(19) United States
(12) Patent Application Publication
(10) Pub. No.: US 2026/0257872 A1
(43) Pub. Date: Sep. 3, 2026

(54) DEVICE FOR GRIPPING AND TRANSPORTING OBJECTS

(71) Applicant: TYROLON GMBH, Hochfilzen (AT)

(72) Inventors: Elmar Schulnig, St. Jakob in Haus (AT); Ludwig Schulning, St. Jakob in Haus (AT)

(21) Appl. No.: 19/163,719

(22) PCT Filed: Mar. 14, 2023
(86) PCT No.: PCT/EP2023/056495

§ 371 Date: Sep. 9, 2025

(51) Int. Cl. B65G 47/86

(52) U.S. Cl. CPC B65G 47/847

(57) ABSTRACT

A device for gripping and transporting objects, for example containers, including a shaft, an arrangement which includes at least one carrier which is arranged in a manner secured against rotation on the shaft, wherein an axial position of the arrangement along the shaft can be adjusted, and at least one gripping apparatus arranged on the carrier. Each gripping apparatus includes a gripping arm pair for gripping one of the objects. The device includes an adjusting mechanism for adjusting the axial position of the arrangement along the shaft, the adjusting mechanism including a toothed rack formed on the shaft and a transmission shaft which is mounted in a rotatable manner in the arrangement and interacts with the toothed rack.

### CROSS REFERENCE TO RELATED PATENT APPLICATIONS

This is a U.S. national phase patent application of PCT/EP2023/056495 filed Mar. 14, 2023, the entire contents of which are incorporated herein by reference for all purposes.

### TECHNICAL FIELD

The invention relates to a device for gripping and transporting objects, for example containers, comprising: a shaft; an arrangement which comprises at least one carrier, which arrangement is arranged in a manner secured against rotation on the shaft; at least one gripping apparatus arranged on the carrier, wherein each gripping apparatus comprises a gripping arm pair for gripping one of the objects; and an adjusting mechanism for adjusting an axial position of the arrangement along the shaft.

### BACKGROUND

EP 3 239 078 A1 discloses a height-adjustable transporting apparatus having a positioning plate and twelve gripping apparatuses, as well as having an actuating device and a locking mechanism. Each gripping apparatus has a gripping arm pair made up of two gripping arms having gripping portions, two bearing pins for the gripping arms, a switching axis having a switching claw and a receiving base in which the bearing pins and the switching axis are fastened. The positioning plate and the gripping apparatuses fastened thereon can be rotated by means of a drive shaft of the transporting apparatus and, in order to avoid an imbalance, are arranged and/or configured axially symmetrically about a drive shaft. The actuating device is mounted in a rotatable manner on the drive shaft so that the actuating device does not rotate as well during the operation of the transporting apparatus and always actuates the gripping apparatuses, in particular the switching claws, in at least one specific position. A locking mechanism is additionally used in order to completely prevent a rotation of the actuating device with the drive shaft. The locking mechanism is configured as a web extending from the actuating device and is connected to an unmovable object or, respectively an object which does not rotate with the drive shaft. Both the positioning plate and the actuating device are connected to the drive shaft and can be displaced (vertically) along said drive shaft. Nevertheless, to ensure that the positioning plate also rotates with the drive shaft, the positioning plate can either be displaced along vertically running grooves or, respectively rails at the connection point between the positioning plate and the drive shaft, or is fixed to the drive shaft with a fastening element. Said fastening element can also serve to lock the height of the positioning plate on the drive shaft. A further height-adjustable transporting apparatus has a pneumatic or hydraulic actuating drive. Yet another transporting apparatus has a height-adjustable positioning plate, a fixed carrier plate, a fixing plate, and a handwheel as a manual actuating drive for adjusting the height of the positioning plate. The handwheel is arranged coaxially to a drive shaft and is provided with a spindle having a helical thread. The spindle is mounted in a rotatable manner in the fixing plate and extends through a spindle nut of the positioning plate up to the carrier plate. The spindle nut is firmly integrated in the positioning plate.

In order to change the height of the positioning plate and, therefore, that of the gripping apparatuses, the fastening element would have to be loosened, the positioning plate displaced manually and the new height fixed by means of the fastening element. This is cumbersome and a precise height adjustment is, in addition, difficult. Pneumatic or hydraulic actuating drives increase the costs and weight of the device. A spindle interacting with a spindle nut requires an additional fixing plate. This makes access to the gripping apparatuses more difficult. As a result, replacing or cleaning the gripping apparatuses becomes more cumbersome. If the drive shaft were to be combined with the spindle, this would lead to the problem that the carrier plate has to be mounted on the shaft with a precise fit and, therefore, the thread would be stressed by the carrier plate.

### SUMMARY

The object of the invention is to indicate a device of the type mentioned at the outset which can have a compact and lightweight design, but which makes it possible to adjust the height of the carrier provided with the gripping apparatuses in a precise and relatively uncomplicated manner.

The object is achieved by the device according to the invention for gripping and transporting objects, for example containers, which is characterised in that the device comprises an adjusting mechanism for adjusting the axial position of the arrangement along the shaft, which comprises a toothed rack configured on the shaft and a transmission shaft which is mounted in a rotatable manner in the arrangement and interacts with the toothed rack.

The device is particularly suitable for gripping, holding and guiding containers, wherein the container is held by a gripping arm pair of one of the gripping apparatuses. The containers can in particular be containers having an elongated portion which is gripped and held by the apparatus. Bottle-shaped containers having a bottle neck are prototypical of this. Depending on the design of the arms, the bottle can be a glass or a plastic bottle. The device is also suitable for transporting other containers. These other containers are, by way of example, cans or glasses, or generally containers having a round cross-section.

The shaft is rotatably arranged about a fixed rotational axis. In most applications, the rotational axis is aligned vertically. The carrier is arranged on the shaft in a manner secured against rotation so that it rotates with the shaft, that is to say cannot rotate opposite it. The carrier can, for example, be designed as a carrier wheel. In one embodiment, it has a plate-shaped design. At least one, as a general rule multiple, gripping apparatus(es) is/are fixedly arranged on the carrier. In particular, they can be arranged along the circumference of the carrier, wherein the gripping arms extend mainly in the radial direction. An object can be guided with the device in a rotational position between the arms of one of the gripping apparatuses and gripped firmly and released again in a further rotational position. For example, objects such as bottles can thus be transferred from one transport line to the next with the device. The gripping apparatuses can have actuators for pivoting the gripping arms or can be operated remotely.

The carrier and, therefore, the gripping apparatuses arranged on the carrier are part of an arrangement which can be axially adjusted as a whole. The fact that an adjusting mechanism is provided means that the arrangement does not need to be moved manually in the axial direction. A toothed rack can be formed in the shaft, but does not need to extend over the entire circumference of the shaft. It simply needs to extend in the axial direction. Consequently, the shaft can otherwise basically have a (circular) cylindrical design, wherein the cylindrical casing surface forms the main part of the circumference of the shaft. This allows a precise fit between a hub of the carrier and the shaft. There is little or no skewing or non-circular movement of the carrier, even if objects are only held by the gripping apparatuses on one side. Teeth can be substantially defined by notches transverse to the axial direction. Said teeth are more robust than a thread. Since the transmission shaft is mounted in a rotatable manner in the arrangement and interacts directly with the toothed rack, a further axially fixed plate is not required. One end of the shaft can therefore be free during operation. As a result, access to the gripping apparatuses, for example for cleaning or maintenance purposes, or in order to replace the arms, is facilitated.

The transmission shaft can be rotated in a variety of ways. Since the height of the arrangement is, as a general rule, not changed frequently, this can be done, by way of example, with a tool which is not part of the arrangement. This makes the arrangement lighter. However, it is also possible to provide an electric, electromagnetic, pneumatic or hydraulic drive.

The transmission shaft does not need to have an elongated form. It can also be designed to be substantially wheel-shaped, for example as a gear having a rotational axis transverse to the shaft axis.

In one embodiment, however, the transmission shaft is mounted in a rotatable manner about an axis of rotation aligned substantially parallel to the toothed rack.

As a result, the arrangement remains relatively compact in the radial direction (based on the rotational axis of the shaft).

In one embodiment, the transmission shaft is a worm shaft.

A worm shaft has a helical winding. In combination with the toothed rack, a rotational movement of the transmission shaft is thus converted into a linear movement of the arrangement along the shaft. The axis of rotation of a worm shaft can be aligned substantially parallel to the longitudinal direction of the toothed rack. The gear ratio can be adjusted via the pitch of the winding.

In one embodiment, the arrangement can be inserted onto the shaft or, respectively can be removed from the shaft via a first axial end of the shaft, and the shaft can be coaxially connected to a drive shaft at an opposite second end.

Consequently, the shaft and axially adjustable arrangement form one unit which can be separated from the drive shaft, for example for maintenance or cleaning purposes. To ensure that the second end is accessible, the axially adjustable arrangement can, in addition, be removed from the shaft via the first end without having to first remove further parts. To this end, depending on the position and form of the transmission shaft, the toothed rack can extend up to the first end.

In one example of this embodiment, a connecting flange for connecting the shaft to the drive shaft is provided at the second end.

The flange can be configured in one piece with the shaft, connected thereto in a firmly bonded manner, or installed thereon by means of a positive fit and/or in a frictionally engaged manner. The flange connection is relatively stable and allows a fairly precise coaxial arrangement of the drive shaft and the shaft.

In one embodiment of the device, the arrangement can be inserted onto the shaft or, respectively can be removed from the shaft via a first axial end of the shaft, and the transmission shaft is mounted in a rotatable manner in a part of the arrangement, which is arranged at an end of the arrangement closest to the first end.

No further device part is arranged radially close to the shaft between the free, first end of the shaft and the end of the arrangement axially closest to the first end, at least in the region closest to the shaft when viewed in the radial direction. Consequently, said axial end of the arrangement which can be axially adjusted in position is easily accessible. A separate tool can be utilised, by way of example, in order to rotate the transmission shaft.

In one embodiment of the device, the transmission shaft has a portion for coupling at least one tool or an actuator at one end.

Said portion will be exposed and/or project. Since an adjustment is only made every now and again, the arrangement does not need to have its own actuator.

In one example of an embodiment in which the arrangement can be inserted onto the shaft or, respectively can be removed from the shaft via a first axial end of the shaft, wherein the transmission shaft is mounted in a rotatable manner in a part of the arrangement, which is arranged at an end of the arrangement closest to the first end, and wherein the transmission shaft has a portion for coupling at least one tool or an actuator at one end, the portion is arranged at an end of the transmission shaft closest to the first end.

The actuator or the tool can therefore be positioned from above in order to adjust the axial position of the arrangement.

In one embodiment of the device, the carrier comprises a round body and the gripping arms protrude with respect to a circumferential edge of the round body.

The body can have a disc-shaped or wheel-shaped basic form.

In one embodiment of the device, the transmission shaft is mounted in a rotatable manner on or in the carrier.

As a result, the number of parts is reduced. In addition, the height adjusting mechanism and the gripping apparatuses are located approximately in one plane in a common axial position.

An embodiment of the device further comprises an apparatus for forming a reversible frictional connection between the arrangement and the shaft.

As a result, the adjusted axial position is secured, and the adjusting mechanism is relieved. However, the shaft can still have a mainly (circular) cylindrical casing surface. The clamping apparatus can act directly on said surface.

In one embodiment of the device, each gripping apparatus has at least one actuating portion which, upon actuation, is adapted in order to produce a pivoting of at least one of the arms of the gripping arm pair about a respective pivot axis, wherein the arrangement comprises at least one component which can be moved relative to the carrier in the rotational direction and is adapted, upon rotation of the shaft, to actuate the respective actuating portion of the gripping apparatus in order to pivot the at least one arm.

Since the arrangement comprises the component(s), the axial position of said component(s) can be adjusted by means of the adjusting mechanism. The axial distance of the gripping apparatuses from the component can be fixed once, which does not then change upon actuation of the adjusting mechanism. The component or components can define a control cam which, upon rotation of the shaft over at least one angular position range, actuates the respective actuating portion of the gripping apparatus to pivot the at least one arm.

An example of this embodiment further comprises at least one locking web rigidly connected to the at least one component, which extends in a mainly radial direction and is adapted for coupling to an object which is stationary with respect to the shaft.

As a result, it is ensured that the gripping arm pairs of the gripping apparatuses open and close when the shaft is rotated. The component or, respectively the components does or, respectively do not also rotate. The connection can allow a relative axial movement between the component with respect to the locking web, or not permit any relative movement at all.

In one example of one of the embodiments in which each gripping apparatus has at least one actuating portion which, upon actuation, is adapted in order to produce a pivoting of at least one of the arms of the gripping arm pair about a respective pivot axis, and wherein the arrangement comprises at least one component which can be moved relative to the carrier in the rotational direction and is adapted, upon rotation of the shaft, to actuate the respective actuating portion of the gripping apparatus to pivot the at least one arm, each gripping apparatus comprises at least one switching shaft arranged in a rotatable manner about a pivot axis by actuation of one of the at least one actuating portions, wherein the switching shaft can be axially adjusted with the arrangement.

This reduces the adjustment complexity upon adjusting the axial position of the carrier with the gripping apparatuses. In addition, the gripping apparatus forms one unit with the switching shaft, which can be easily dismantled. There is no need to provide separately mounted switching shafts, along which the gripping apparatuses are shifted.

In one example of this embodiment, the actuating portion comprises a lever arranged on the switching shaft and extending from said switching shaft, for example in the form of a roller lever.

In this embodiment, the at least one component can, for example, define a control cam by radial distance from the rotational axis of the shaft. The switching shaft remains at the same radial distance from the rotational axis of the shaft. The lever end is relocated when the carrier having the gripping apparatuses performs a rotational movement relative to the component. Even if the actuating portion does not move along a control cam, but rather engages with the component or one of the components in another way, such an effect is attained.

In one example of any of the embodiments in which each gripping apparatus has at least one actuating portion which, upon actuation, is adapted in order to produce a pivoting of at least one of the arms of the gripping arm pair about a respective pivot axis, wherein the arrangement comprises at least one component which can be moved relative to the carrier in the rotational direction and is adapted, upon rotation of the shaft, to actuate the respective actuating portion of the gripping apparatus to pivot the at least one arm, and wherein each gripping apparatus comprises at least one switching shaft arranged in a rotatable manner about a pivot axis by actuation of one of the at least one actuating portions, wherein the switching shaft can be axially adjusted with the arrangement, each gripping apparatus is configured such that pivoting movements of the arms of a gripping arm pair are coupled about their respective pivot axes.

As a result, one switching shaft is sufficient for each gripping apparatus. Additionally, the arms of a gripping arm pair move synchronously apart and towards one another.

In a further example of any of the embodiments in which each gripping apparatus has at least one actuating portion which, upon actuation, is adapted in order to produce a pivoting of at least one of the arms of the gripping arm pair about a respective pivot axis, wherein the arrangement comprises at least one component which can be moved relative to the carrier in the rotational direction and is adapted to actuate the control cam, upon rotation of the shaft, the respective actuating portion of the gripping apparatus to pivot the at least one arm, and wherein each gripping apparatus comprises at least one switching shaft arranged in a rotatable manner about a pivot axis by actuation of one of the at least one actuating portions, wherein the switching shaft can be axially adjusted with the arrangement, each gripping apparatus comprises an apparatus for generating a reset force which leads to a torque acting on the switching shaft.

The reset force can in particular produce a pivoting towards one another of the arms of the gripping arm pair, that is to say to force the gripping arm pair into a closed position. At the same time, it is guaranteed by the reset force that the actuating portion does not move away from the component or, respectively components, for example of a control cam defined by it/them.

Consequently, a positive connection between the component, for example the control cam, and the actuating portion is not required. This simplifies the installation and maintenance of the device.

In one embodiment of the device, each gripping apparatus comprises at least one base as a carrier of at least one of the arms, on which the arm or, respectively the arms is or, respectively are mounted in a rotatable manner, wherein the base is an integral part of the carrier of the device.

This reduces the outlay in terms of installation, leads to a weight saving and simplifies an embodiment in which (only) the arms of the gripping apparatuses can be replaced.

### DESCRIPTION OF DRAWINGS

The invention is explained in more detail with reference to the accompanying drawings, in which:

FIG. 1 is a perspective view of a first transporting device;

FIG. 2 is a top view of the first transporting device;

FIG. 3 is a bottom view of the first transporting device;

FIG. 4 is a side view of the first transporting device which only shows one gripping apparatus;

FIG. 5 is a perspective view of parts of the first transporting device;

FIG. 6 is a side view of parts of the first transporting device;

FIG. 7 is a perspective view of one of the gripping apparatuses comprised in the first transporting device;

FIG. 8 shows a cross-section through an axially adjustable part of the first transporting device;

FIG. 9 shows a cross-section through an axially adjustable part of a modified variant of the first transporting device;

FIG. 10 is a top view of a second transporting device;

FIG. 11 is a perspective view of the second transporting device;

FIG. 12 is a perspective view of parts of the second transporting device;

FIG. 13 is a side view of parts of the second transporting device;

FIG. 14 is a second perspective view of parts of the second transporting device;

FIG. 15 is a top view of a gripping apparatus for the second transporting device; and

FIG. 16 is a side view of the gripping apparatus shown in FIG. 14.

### DESCRIPTION OF AN EMBODIMENT

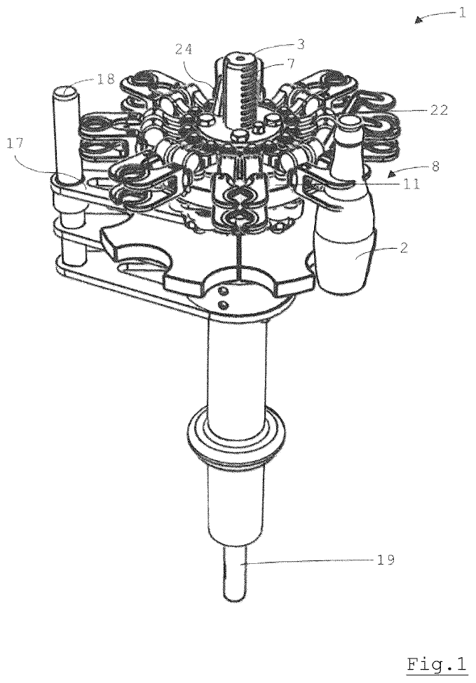

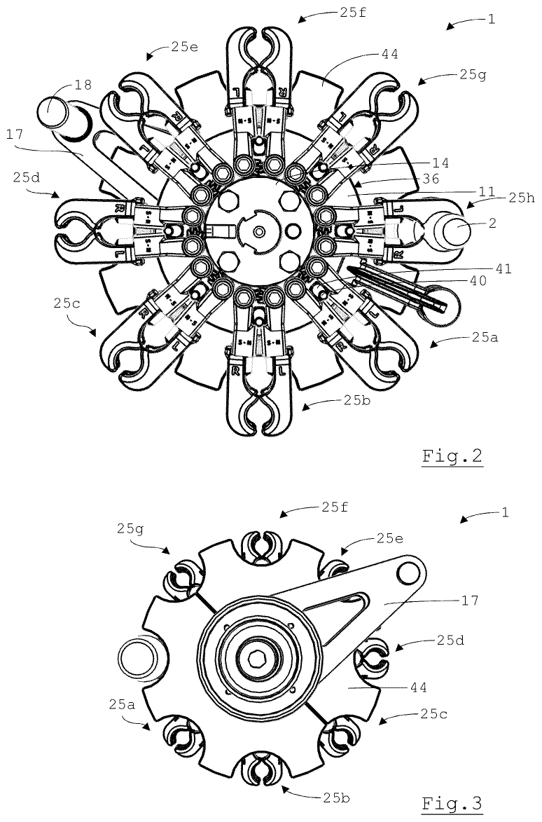

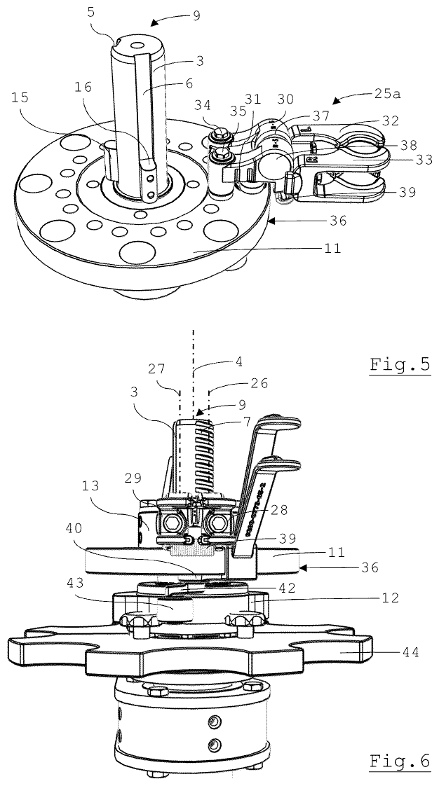

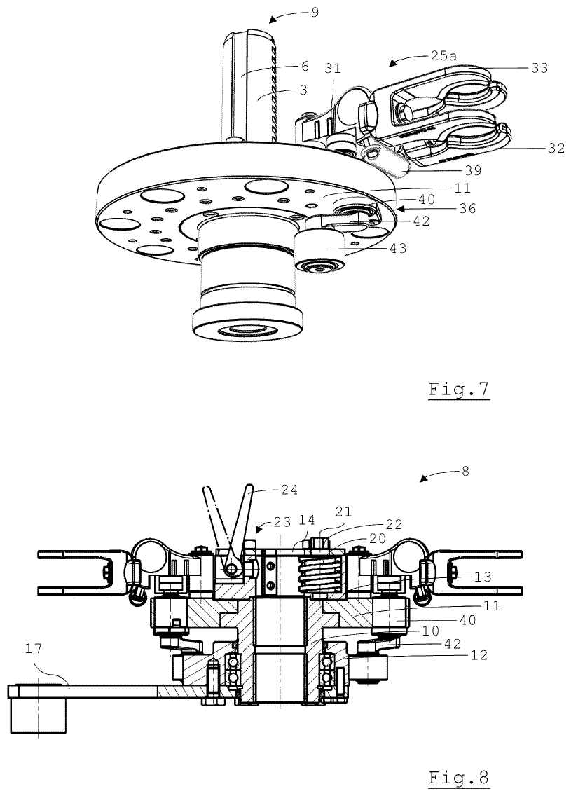

A first transporting device 1 (FIGS. 1-8) for a bottle-shaped container 2 (FIG. 1) is first explained in more detail below, which is, however, in principle also suitable for conveying other types of objects, or can be adapted for this purpose.

The first transporting device 1 comprises a shaft 3. The shaft 3 has a (circular) cylindrical basic form. However, two grooves 5,6 extending in the axial direction (based on a rotational axis 4 of the shaft 3) are configured in the shaft 3. The shaft 3 further has a toothed rack 7 formed by notches running transversely to the rotational axis 4, likewise extending in the axial direction.

The first transporting device 1 comprises an assembly 8 arranged on the shaft 3 (FIG. 8). The assembly 8 can be inserted onto the shaft 3 via a first end 9 of the shaft 3. It comprises a hub 10, a carrier plate 11, a control cam carrier 12 and a base part 13 of an adjusting mechanism which is provided with a cover plate 14. The carrier plate 11 is rigidly connected to the hub 10. The base part 13 of the adjusting mechanism is also rigidly connected to the hub 10. The control cam carrier 12 is mounted on the hub 10 so that it can rotate about the hub 10. A rotational axis of the control cam carrier 12 is aligned coaxially with the rotational axis 4. Consequently, the control cam carrier 12 can be moved with respect to the carrier plate 11 in the rotational direction. However, the parts of the assembly 8 are not movable with respect to one another in the axial direction, at least during operation. In the depicted embodiment, the relative axial position cannot be modified at all. In an alternative embodiment, means for adjusting the relative axial position can be provided. However, this adjustment would then be retained during operation.

The base part 13 is arranged on the shaft 3 in a manner secured against rotation. In the depicted embodiment, two springs 15,16 are provided for this purpose, which each interact with one of the grooves 5,6. Since the base part 13 is rigidly connected to the carrier plate 11, the carrier plate 11 is also arranged on the shaft 3 in a manner secured against rotation.

A first locking web 17 is rigidly connected to the control cam carrier 12 and extends in the radial direction. At an end remote from the rotational axis 4, the locking web 17 has a passage through which a column 18 is guided. The position of the column 18 is fixed with respect to the rotational axis 4. Consequently, the control cam carrier 12 cannot also rotate with the carrier plate 11 and the shaft 3.

At a second end (which is not visible in the drawings) opposite the first end 9, the shaft 3 is at least indirectly rigidly and coaxially connected to a drive shaft 19. Consequently, the assembly 8 and the shaft 3 are part of one unit which can be detached from the drive shaft 19. The connection to the drive shaft 19 can, by way of example, comprise a flange connection.

The adjusting mechanism comprises a worm shaft 20 which is mounted in a rotatable manner in the base part 13 and which interacts with the toothed rack 7. The worm shaft 20 can be rotated about an axis of rotation 21 which is aligned substantially parallel to the rotational axis 4. As a result, the base part 13 can have a relatively compact design in the radial direction. The cover plate 14 encloses the worm shaft 20 in the base part 13 in the axial direction. An end portion 22 of the worm shaft 20 has a polygonal cross-section and projects with respect to the cover plate 14. Since the base part 13 forms the part of the assembly 8 which is closest to the free, first end 9 of the shaft 3 in the axial direction, the end portion 22 is relatively easily accessible for locating a tool or for coupling an actuator. No further parts of the transporting device 1 are provided between the free, first end 9 of the shaft and the assembly 8.

The axial position of the assembly 8 can be adjusted by rotating the worm shaft 20 about its axis of rotation 21.

In the depicted embodiment, a clamping apparatus 23 (FIG. 8) is, in addition, provided for forming a reversible frictional connection between the assembly 8, in particular the part of the assembly 8 arranged in a manner secured against rotation, and the shaft 3. In this embodiment, the clamping apparatus 23 acts directly on the outer surface of the shaft 3. The clamping apparatus 23 can be operated by means of a lever 24. Said lever 24 also projects with respect to the base part 13, in particular with respect to the cover plate 14. Other types of clamping apparatus are possible, for example those which comprise a clamp or loop. The clamping apparatus 23 secures the axial position of the assembly 8 which has been adjusted by means of the adjusting mechanism.

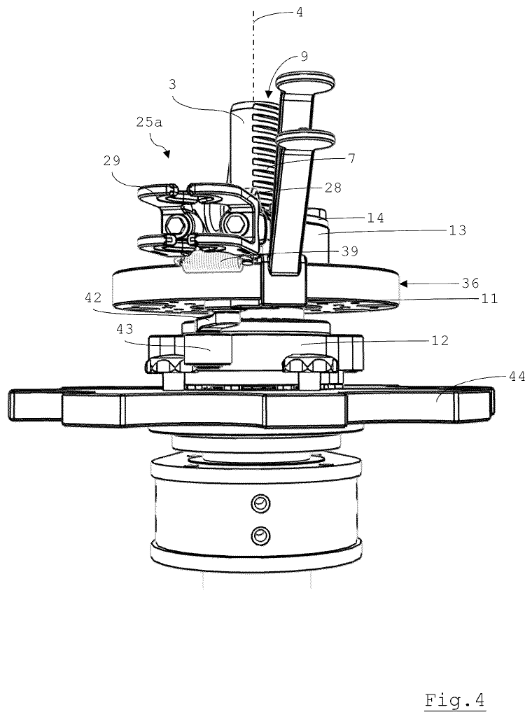

In the depicted embodiment, eight gripping apparatuses 25a-h are arranged in a distributed manner along the circumference of the carrier plate 11 (FIGS. 1-3). They have the same design, so that the construction thereof is explained on the basis of an exemplary gripping apparatus 25a (FIGS. 4-7).

The gripping apparatus 25a has gripping arms 28,29 pivotably arranged about respective pivot axes 26,27. Each gripping arm 28,29 comprises a gripping arm body 30,31 and a gripping portion 32,33 which is replaceably connected thereto. Each gripping arm 28,29, in the example each gripping arm body 30,31, is connected to the carrier plate 11 via a bearing element 34,35.

The bearing elements 34,35 define the respective pivot axes 26,27 of the gripping arms 28,29. At least the gripping portions 32,33 protrude with respect to a circumferential edge 36 of the carrier plate 11 in a mainly radial direction.

The pivoting movements of the gripping arms 28,29 are synchronised by interlocking teeth. In addition, interacting magnets 37,38 are arranged in the gripping arms 28,29 at a radial distance from the respective pivot axis 26,27. A reset device in the form of a reset spring 39 connects the gripping arms 28,29. Both the magnets 37,38 and the reset spring 39 exert a force which moves the gripping arms 28,29 towards one another.

The gripping apparatus 25a comprises a switching shaft 40 which is mounted in a rotatable manner on the carrier plate 11 and extends through said carrier plate in the axial direction. At one axial end, a control element 41 is arranged which, upon rotation of the switching shaft 40 about an axis of rotation of the switching shaft 40, exerts a force on at least one of the gripping arms 28,29 and thus generates a torque which moves the gripping arms 28,29 apart. Said torque acts against the torque generated by the magnets 37,38 and the reset spring 39. An actuating portion in the form of a roller lever 42 is arranged at the other end of the switching shaft 40. A roller 43 of the roller lever 42 is pressed by the torque generated by the magnets 37,38 and the reset spring 39 against one or more on the circumference of the control cam carrier 12. During the movement of the roller 43 along the control cam or control cams, the radial position of the roller 43 is modified (with regard to the rotational axis 4).

The control element 41 and the roller lever 42 are arranged immovably relative to the switching shaft 40 during operation. The switching shaft 40 is arranged in an axially non-shiftable manner on the carrier plate 11. Since the axial distance of the control cam carrier 12 from the carrier plate 11 does not change, upon adjustment of the axial position of the assembly 8, the roller 43 remains in the correct axial position with regard to the control cam or cams with which it interacts.

In the depicted embodiment, the first transporting device also comprises a base plate 44 having indentations for receiving a bottle belly. In the example, the base plate 44 is embodied in two parts and can be removed. It can be rotated about an axis of rotation which is aligned coaxially with the rotational axis 4. The rotational movement is coupled to that of the shaft 3. However, the axial position of the base plate 44 cannot be adjusted together with that of the assembly 8. Consequently, the first transporting device 1 can be adjusted to containers of different heights.

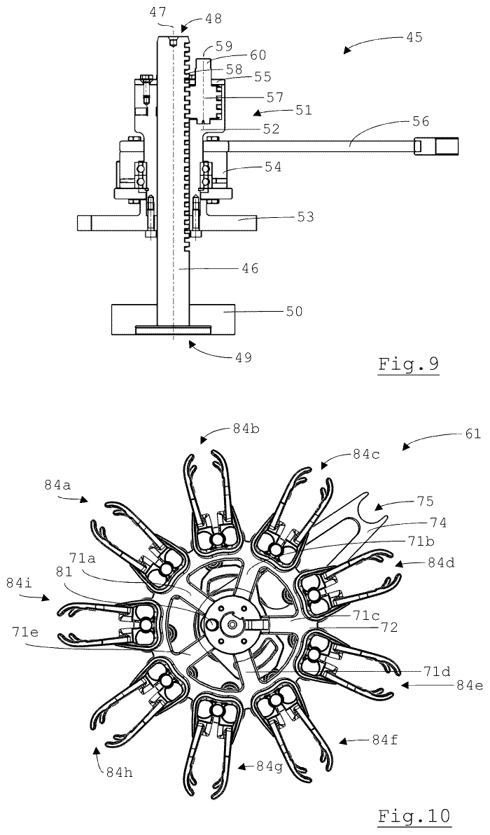

A modified variant 45 (FIG. 9) of the first transporting device 1 also comprises a shaft 46 which can be rotated about a rotational axis 47. It has a first axial end 48 and an opposite second axial end 49. The first end 48 is a free end during operation. A flange 50 for detachably connecting the shaft 46 to a drive shaft (not depicted) is provided at the second end 49.

The device variant 45 also comprises an assembly 51 arranged on the shaft 46. The assembly 51 can be inserted onto the shaft 46 via the first end 48 of the shaft 46. It comprises a hub 52, a carrier plate 53 and a control cam carrier 54. Where the first transporting device 1 still comprised a base part 13 of an adjusting mechanism, this is integrated into the hub 52 in the device variant 45. The hub 52 is provided with a cover plate 55.

The carrier plate 53 is rigidly connected to the hub 52. The control cam carrier 54 is mounted on the hub 52 so that it can rotate about the hub 52. A rotational axis of the control cam carrier 54 is aligned coaxially with the rotational axis 47. Consequently, the control cam carrier 54 can be moved with respect to the carrier plate 53 in the rotational direction. However, the parts of the assembly 51 are not movable with respect to one another in the axial direction, at least during operation.

The hub 52 is arranged on the shaft 46 in a manner secured against rotation in the same way as the base part 13. Since the hub 52 is rigidly connected to the carrier plate 53, the carrier plate 53 is also arranged on the shaft 46 in a manner secured against rotation.

A locking web 56 is rigidly connected to the control cam carrier 54 and extends in the radial direction. At an end remote from the rotational axis 47, the locking web 56 has a passage through which a column can be guided, the position of which is fixed with respect to the rotational axis 47. Consequently, the control cam carrier 54 cannot also rotate with the carrier plate 53 and the shaft 46.

The adjusting mechanism for adjusting the axial position of the assembly 51 comprises a worm shaft 57 which is mounted in a rotatable manner in the hub 52 and which interacts with a toothed rack 58 configured in the shaft 46. The worm shaft 57 can be rotated about an axis of rotation 59 which is aligned substantially parallel to the rotational axis 47. The cover plate 55 encloses the worm shaft 57 in the axial direction in the hub 52. An end portion 60 of the worm shaft 57 has a polygonal cross-section and projects with respect to the cover plate 55. Since the portion of the hub 52 in which the worm shaft 57 is arranged forms the part of the assembly 51 closest to the free, first end 48 of the shaft 46 in the axial direction, the end portion 60 for locating a tool or for coupling an actuator is relatively easily accessible. No further parts of the transporting device variant 45 are provided between the free, first end 48 of the shaft and the assembly 51.

The axial position of the assembly 51 can be adjusted by rotating the worm shaft 57 about its axis of rotation 59. A clamping apparatus (not depicted) such as the clamping apparatus 23 of the first transporting device 1 can be provided to secure said position.

That is to say, it can be seen that the assembly 51 is not simply an inverted version of the assembly 8 of the first transporting device 1. The worm shaft 57 is always arranged on a portion of the assembly 51, which is located closer to the first, free end 48 of the shaft 46 in the axial direction than the carrier plate 53. As a result, the gripping apparatuses (not depicted in FIG. 9) arranged on the carrier plate 53 do not make access to the adjusting mechanism more difficult.

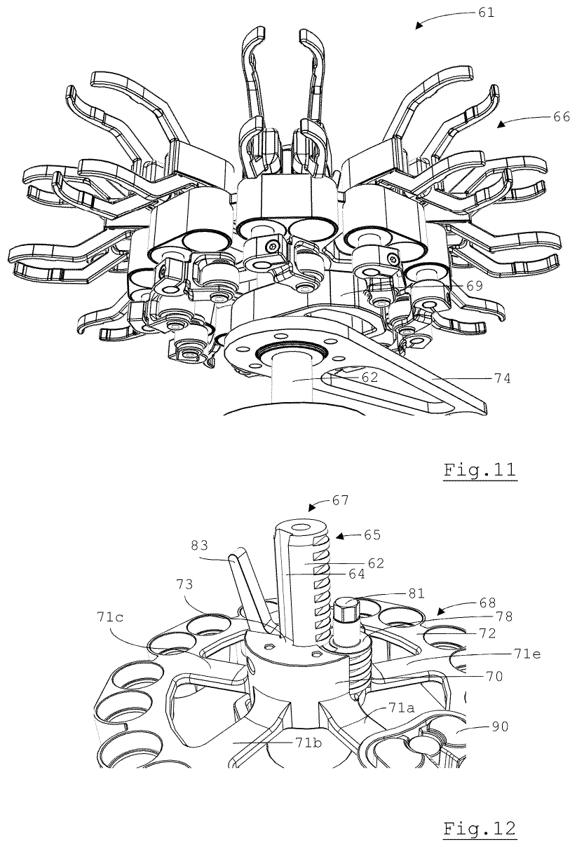

This principle is also utilised in a second transporting device 61 (FIGS. 10-16).

The second transporting device 61 also comprises a shaft 62 which has a (circular) cylindrical basic form. However, a single groove 64 extending in the axial direction (based on a rotational axis 63 of the shaft 62) is configured in the shaft 62. The shaft 62 further has a toothed rack 65 formed by notches running transversely to the rotational axis 63 and likewise extending in the axial direction. The second transporting device 61 likewise comprises an assembly 66 arranged on the shaft 62. The assembly 66 can be inserted onto the shaft 62 via a first end 67 of the shaft 62. Said assembly 66 comprises a carrier wheel 68 and a control cam carrier 69.

The carrier wheel 68 has an integral hub 70, spokes 71a-e functioning as connecting webs and a continuous circumferential portion 72. In an alternative embodiment, the carrier wheel 68 can be configured in multiple parts. However, the one-piece design leads to a weight saving and a reduction in the mass inertia.

The control cam carrier 69 is mounted on the hub 70 so that it can rotate about the hub 70. A rotational axis of the control cam carrier 69 is aligned coaxially with the rotational axis 63. Consequently, the control cam carrier 69 can be moved with respect to the carrier wheel 68 in the rotational direction. However, the parts of the assembly 66 are not movable with respect to one another in the axial direction, at least during operation.

The hub 70 is arranged on the shaft 62 in a manner secured against rotation by means of a portion 73 engaging in the groove 64.

In one embodiment, the shaft 62 can be configured such that at least two grooves extending in the axial direction are provided. In this embodiment, it is consequently possible, in the case of a corresponding configuration of the transporting device 61, in particular by providing multiple portions 73, to guarantee an arrangement of the hub 70 in a manner secured against rotation on the shaft 62. By providing more than one groove 64, it is possible to insert the hub 70 onto the shaft 62 in different ways. By way of example, four grooves can be provided, which are provided at equidistant intervals on the shaft 62. Consequently, the hub 70 can also be inserted onto the shaft 62 with a 90° rotation.

A locking web 74 is rigidly connected to the control cam carrier 69 and extends in the radial direction. At an end remote from the rotational axis 63, the locking web 74 has a fork 75 with which it can be held by an object comparable to the column 18. Consequently, the control cam carrier 69 cannot also rotate with the carrier wheel 68.

At a second end 76 opposite the first end 67, the shaft 62 can be connected, at least indirectly, rigidly and coaxially to a drive shaft. A flange 77 is provided for this purpose. Consequently, the assembly 66 and the shaft 62 are part of one unit which can be connected to a drive shaft and which can be detached from it again relatively easily.

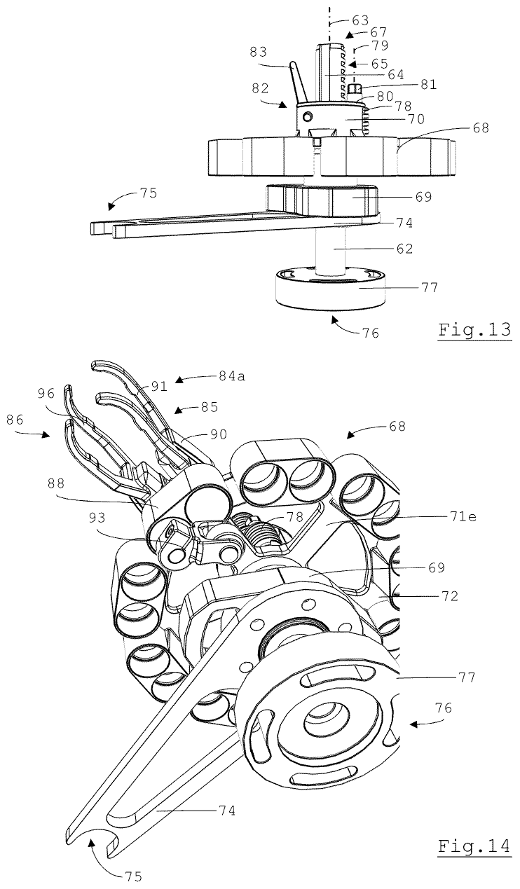

The adjusting mechanism comprises a worm shaft 78 which is mounted in a rotatable manner on the hub 70 and which interacts with the toothed rack 65. The worm shaft 78 can be rotated about an axis of rotation 79 which is aligned substantially parallel to the rotational axis 63. As a result, the hub 70 can have a relatively compact design in the radial direction. This effect is increased by the hub 70 being open towards the side in the region of the worm shaft 78. However, a cover plate 80 (FIG. 13) encloses the worm shaft 78 in the hub 70 in the axial direction.

An end portion 81 of the worm shaft 78 has a polygonal cross-section and projects with respect to the cover plate 80. Since the portion of the hub 70 on which the worm shaft 78 is mounted forms the part of the assembly 66, which is closest to the free, first end 67 of the shaft 62 in the axial direction, the end portion 81 for locating a tool or for coupling an actuator is comparatively easily accessible. No further parts of the transporting device 61 are provided between the free, first end 67 of the shaft and the assembly 66.

The axial position of the assembly 66 can be adjusted by rotating the worm shaft 78 about its axis of rotation 79.

In the depicted embodiment, a clamping apparatus 82 (FIG. 13) is, in addition, provided for forming a reversible frictional connection between the assembly 66, in particular the part of the assembly 66 arranged in a manner secured against rotation, and the shaft 62. In this embodiment, the clamping apparatus 82 acts directly on the outer surface of the shaft 62. The clamping apparatus 82 can be operated by means of a lever 83. Said lever 83 also projects with respect to the hub 70, in particular with respect to the cover plate 80. Other types of clamping apparatuses are possible, for example those which comprise a clamp or loop. The clamping apparatus 82 secures the axial position of the assembly 66, which has been adjusted by means of the adjusting mechanism.

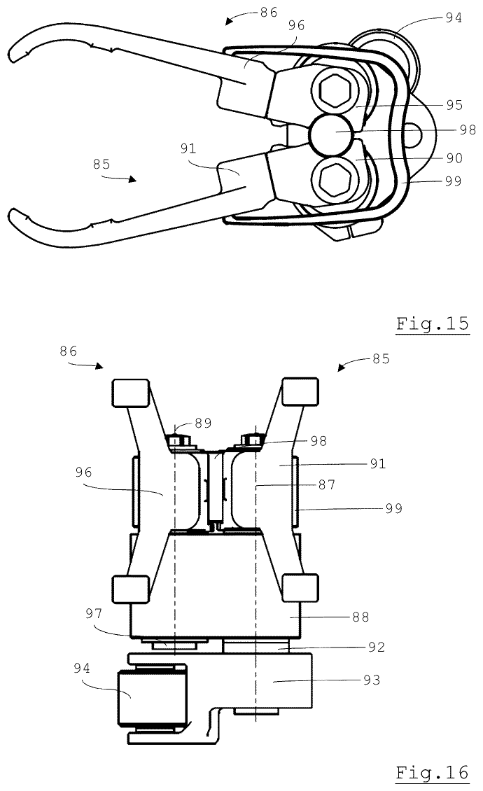

In the depicted embodiment, nine gripping apparatuses 84a-i are arranged in a distributed manner along the circumference of the carrier wheel 68, in particular along the circumferential portion 72. They have the same design, so that the construction thereof is explained on the basis of an exemplary gripping apparatus 84 (FIGS. 15-16). Further details of the gripping apparatus 84 can, in addition, be found in European patent application No. 21170053.9 of 23 Apr. 2021.

The gripping apparatus 84a comprises a first arm 85 and a second arm 86. The first arm 85 and the second arm 86 form a gripping arm pair. In the depicted embodiment, only a single gripping arm pair is provided per gripping apparatus. However, more than one gripping arm pair can also be provided.

The first arm 85 is mounted on a double housing 88 so that it can rotate about a first pivot axis 87 (FIG. 16). The second arm 86 is mounted on the double housing 88 so that it can rotate about a second pivot axis 89. In an alternative embodiment, separate housings can be provided in place of the double housing 88.

In the implementation in the second transporting device 61, the double housing 88 is an integral part of the carrier wheel 68, i.e., is configured in one piece therewith. This reduces the outlay in terms of installation.

The pivot axes 87,89 are aligned substantially parallel to one another and, in the depicted embodiment, are also aligned substantially parallel to the rotational axis 63 of the assembly 66.

It is possible to imagine a centre plane which runs parallel to the two pivot axes 87,89 between the two arms 85,86 and which the arms 85,86 approach, on closing the gripping arm pair, and which they move away from, on opening. In a top view parallel to the pivot axes 87,89, a centre line is produced. If the arms 85,86 are arranged symmetrically, as in the present case, the centre line at least approximately forms an opening angle bisector.

In order to ensure this, the pivoting movements of the first arm 85 and of the second arm 86 are coupled, although the control component of the transporting device only generates a torque exerted on the first arm 85.

In the depicted embodiment (FIGS. 15-16), the first arm 85 is constructed from two parts, namely an inner first arm part 90 and an outer second arm part 91. The first arm part 90 is a substantially solid body. The second arm part 91 functions as a pivot clamp. The second arm part 91 comprises two fingers which are spread in the axial direction (based on the first pivot axis 87), the free ends of which form free ends of the first arm 85. In the depicted embodiment, the fingers are adjusted to the contour of a bottle neck, that is to say curved. The second arm part 91 can be replaced.

The first arm part 90 is fixed to a switching shaft 92 in a manner secured against rotation. The switching shaft 92 is mounted on the double housing 88 and guided through it. A roller lever 93 extending from said switching shaft 92 is arranged at one axial end thereof.

The roller lever 93 has a roller 94 mounted in a rotatable manner. This is adapted to follow the control cam defined by the control cam carrier 69 when the gripping apparatus 84a is guided past the control cam by the relative rotation of the carrier wheel 68. A torque is generated, which is exerted on the first arm 85. The first arm 85 transmits a force to the second arm 86, so that only the external force exerted on the one actuating part moves both arms 85,86. In the depicted embodiment, the gripping arm pair opens against a reset force. In principle, however, an embodiment is also conceivable, in which the gripping arm pair closes against a reset force and the actuating part is adapted to open the gripping arm pair.

Since the roller lever 93 is arranged axially spaced from the first arm 85, it and at least one of the arms 85,86 can overlap when viewed parallel to the pivot axes 87,89. As a result, the footprint of the gripping apparatus 84a is relatively small.

In the depicted embodiment, the second arm 86 is likewise constructed from two parts, namely an inner first arm part 95 and an outer second arm part 96. The first arm part 95 is a substantially solid body. The second arm part 96 functions as a pivot clamp. In the depicted embodiment, the second part 91 of the first arm 85 is the mirror image of the second part 96 of the second arm 86. Since they are themselves symmetrical with regard to a plane of symmetry transverse to the pivot axes 87,89, the second arm parts 91,96 are even structurally identical, only installed arranged in reverse order.

The first arm part 95 of the second arm 86 is the mirror image of the first arm part 90 of the first arm 85. Admittedly, in the depicted embodiment, it has a round bore through which a second shaft 97 is guided. This is mounted in a rotatable manner in the double housing 88 and guided through it.

The second arm parts 91,96 protrude radially outwards with respect to the circumferential portion 72 of the carrier wheel 68.

Recesses facing one another and the above-mentioned centre plane are configured in the first part 90 of the first arm 85 and in the first part 95 of the second arm 86. The recesses substantially have a flute-shaped design; admittedly, they are delimited in the axial direction at the respective ends located closer to the double housing 88. A force transmission body 98 held between the recesses is supported on said delimitations.

The recesses have a round inner contour when viewed in the axial direction. They surround the force transmission body 98 to such an extent that a force directed predominantly parallel to the above-mentioned centre plane can be transmitted via it. A portion of the first part 90 of the first arm 85 and a portion of the first part 95 of the second arm 86 delimit a respective portion of an inner surface of the first recess or, respectively of the second recess. These surface portions have a respective normal which has a main component parallel to the above-mentioned centre plane, at least in the closed condition of the gripping arm pair. In addition, it is located between the pivot axes 87,89, but at a distance from the respective pivot axis 87,89. Consequently, a torque is generated by the transmitted force.

A spring 73 embracing the arms 85,86 exerts a reset force, in the present case a closing force. In other embodiments, other apparatuses for exerting a reset force can be provided additionally or alternatively. Examples can be found in WO 2020/108758 A1.

In the depicted embodiment, the force transmission body 98 is an elongated body. Due to the form of the recesses, the longitudinal axis of the force transmission body extends substantially in the axial direction, based on the pivot axes 87,89. In an alternative embodiment, the force transmission body 98 can be spherical and the recesses can have a cylindrical or spherical design. In the depicted embodiment, the force transmission body 98 is designed as a cylinder having a circular cross-section. A cylindrical form having a polygonal cross-section is also possible. However, the round form leads to a more uniform power transmission and, as a consequence, to less wear and abrasion.

As depicted in FIGS. 15 and 16, the switching shaft 92 is connected to the first arm 85. In the case of the gripping apparatuses 84a-i of the second transporting device 61, as depicted in FIGS. 10-14, it is the second arm 86. That is to say, both arrangements are possible. It is simply the roller lever 93 which has to be arranged in accordance with the arrangement and the rotational direction.

When installed in the assembly 66, the gripping apparatus 84a only has a small extension in the direction of the rotational axis. In addition, it can be manufactured from relatively few components. The double housing 88 is relatively compact in the radial direction (based on the rotational axis 63) since only the switching shaft 92 and the second shaft 62 are mounted in it.

This is due to the fact that the first arm 85 is installed directly on the switching shaft 92. The force transmission body 98 and the reset spring 73 ensure that the pivoting movements of the two arms 85,86 are nevertheless synchronised.

The switching shaft 92 is adjusted with the assembly 66 in the axial direction. As a result, it is relatively short.

The second transporting device 61 is compact and lightweight. In addition, the adjusting mechanism is easily accessible. This also applies to the gripping apparatuses 84a-i.

The invention is not restricted to the depicted embodiments which can be varied within the scope specified by the claims. The control cam carrier 12,69 can be designed, by way of example, as a (circular) cylindrical drum, to the casing surface of which discrete bodies which define the actual control cam portions are detachably fastened. The transporting device can thus be optimised in a more flexible manner for a specific deployment.

### LIST OF REFERENCE NUMERALS

1—1st transporting device
2—Bottle
3—Shaft
4—Rotational axis
5—1st groove
6—2nd groove
7—Toothed rack
8—Axially positionable assembly
9—1st shaft end
10—Hub
11—Carrier plate
12—Control cam carrier
13—Base part
14—Cover plate
15—1st spring
16—2nd spring
17—Locking web
18—Column
19—Drive shaft
20—Worm shaft
21—Axis of rotation
22—End portion
23—Clamping apparatus
24—Lever
25a-h—Gripping apparatuses
26—Left pivot axis
27—Right pivot axis
28—Left gripping arm
29—Right gripping arm
30—Left gripping arm body
31—Right gripping arm body
32—Left gripping portion
33—Right gripping portion
34—Left bearing element
35—Right bearing element
36—Circumferential edge
37—Left magnet
38—Right magnet
39—Reset spring
40—Switching shaft
41—Control element
42—Roller lever
43—Roller
44—Ground plate
45—Device variant
46—Shaft
47—Rotational axis
48—1st end
49—2nd end
50—Flange
51—Assembly
52—Hub
53—Carrier plate
54—Control cam carrier
55—Cover plate
56—Locking web
57—Worm shaft
58—Toothed rack
59—Axis of rotation
60—End portion
61—2nd transporting device
62—Shaft
63—Rotational axis
64—Groove
65—Toothed rack
66—Assembly
67—1st end
68—Carrier wheel
69—Control cam carrier
70—Hub
71a-e—Spokes
72—Circumferential portion
73—Engaging portion
74—Locking web
75—Fork
76—2nd end
77—Flange
78—Worm shaft
79—Axis of rotation
80—Cover plate
81—End portion
82—Clamping apparatus
83—Lever
84a-i—Gripping apparatuses
85—1st arm
86—2nd arm
87—1st pivot axis
88—Double housing
89—2nd pivot axis
90—1st part of the 1st arm
91—2nd part of the 1st arm
92—Switching shaft
93—Roller lever
94—Roller
95—1st part of the 2nd arm
96—2nd part of the 2nd arm
97—2nd shaft
98—Power transmission body
99—Reset spring

1-15. (canceled)

16. A device for gripping and transporting objects, the device comprising:
a shaft;
an arrangement which comprises at least one carrier which is arranged in a manner secured against rotation on the shaft, wherein an axial position of the arrangement along the shaft can be adjusted; and
at least one gripping apparatus arranged on the at least one carrier, wherein each of the at least one gripping apparatus comprises a gripping arm pair for gripping one of the objects, wherein the device comprises an adjusting mechanism for adjusting the axial position of the arrangement along the shaft, which comprises a toothed rack configured on the shaft and a transmission shaft which is mounted in a rotatable manner in the arrangement and interacts with the toothed rack.

17. The device according to claim 16, wherein the transmission shaft is mounted in a rotatable manner about an axis of rotation aligned substantially parallel to the toothed rack.

18. The device according to claim 16, wherein the transmission shaft is a worm shaft.

19. The device according to claim 16, wherein the arrangement can be inserted onto the shaft or, respectively can be removed from the shaft via a first axial end of the shaft, and wherein the shaft can be coaxially connected to a drive shaft at an opposite second end.

20. The device according to claim 19, wherein a connecting flange for connecting the shaft to the drive shaft is provided at the second end.

21. The device according to claim 16, wherein the arrangement can be inserted onto the shaft or, respectively can be removed from the shaft, via a first axial end of the shaft, and wherein the transmission shaft is mounted in a rotatable manner in a part of the arrangement, which is arranged at an end of the arrangement closest to the first end.

22. The device according to claim 21, wherein the transmission shaft has a portion for coupling at least one tool or an actuator at one end.

23. The device according to claim 22, wherein the portion is arranged at an end of the transmission shaft closest to the first end.

24. The device according to claim 16, further comprising an apparatus for forming a reversible frictional connection between the arrangement and the shaft.

25. The device according to claim 16, wherein each of the at least one gripping apparatus has at least one actuating portion which, upon actuation, is adapted in order to produce a pivoting of at least one arm of the gripping arm pair about a respective pivot axis, and wherein the arrangement comprises at least one component which can be moved relative to the at least one carrier in the rotational direction and is adapted, upon rotation of the shaft, to actuate a respective one of the at least one actuating portion of the at least one gripping apparatus in order to pivot the at least one arm.

26. The device according to claim 25, further comprising at least one locking web rigidly connected to the at least one component, which extends in a mainly radial direction and is adapted for coupling to an object which is stationary with respect to the shaft.

27. The device according to claim 26, wherein each of the at least one gripping apparatus comprises at least one switching shaft arranged in a rotatable manner about the pivot axis by actuation of one of the at least one actuating portion, wherein the at least one switching shaft can be axially adjusted with the arrangement.

28. The device according to claim 27, wherein the actuating portion comprises a lever arranged on the switching shaft and extending from the switching shaft.

29. The device according to claim 28, wherein each of the at least one gripping apparatus is configured such that pivoting movements of the at least one arm of a respective one of the gripping arm pair are coupled about the pivot axes.

30. The device according to claim 29, wherein each of the at least one gripping apparatus comprises an apparatus for generating a reset force which leads to a torque acting on the switching shaft.
